(19) United States
(12) Patent Application Publication
(10) Pub. No.: US 2007/0158343 A1
(43) Pub. Date: Jul. 12, 2007

(54) Liner for pressure vessel and process for fabricating same

(75) Inventors: Toshiaki Shimada, Wako-shi (JP); Yasuki Yoshida, Wako-shi (JP); Hirokazu Kuwabara, Wako-shi (JP); Yasuhiro Osame, Oyama-shi (JP); Yasuharu Kanno, Oyama-shi (JP); Yasuji Kawamata, Oyama-shi (JP); Hideyo Yamasaki, Oyama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., Tokyo (JP)

(21) Appl. No.: 10/587,849

(22) PCT Filed: Feb. 8, 2005
(86) PCT No.: PCT/JP05/02190

§ 371 Date: Jul. 28, 2006

Related U.S. Application Data
(60) Provisional application No. 60/544,358, filed on Feb. 17, 2004.

(30) Foreign Application Priority Data
Feb. 9, 2004 (JP) 2004-031871

(51) Int. Cl. B65D 6/00; B60L 8/00

(52) U.S. Cl. 220/4.14; 180/65.3

(57) ABSTRACT

A pressure vessel liner includes a tubular trunk, and head plates for closing opposite end openings of the trunk. Provided inside the trunk is a reinforcing member integral with the trunk and extending longitudinally of the trunk for dividing the interior of the trunk into a plurality of spaces. The two head plates are joined respectively to opposite ends of the reinforcing member. The pressure vessel liner has an enhanced pressure resistant strength against longitudinal forces.

### CROSS REFERENCE TO RELATED APPLICATION

This application is an application filed under 35 U.S.C. §111(a) claiming the benefit pursuant to 35 U.S.C. §119(e) (1) of the filing date of Provisional Application No. 60/544,358 filed Feb. 17, 2004 pursuant to 35 U.S.C. §111(b).

### TECHNICAL FIELD

The present invention relates to liners for use in pressure vessels for storing hydrogen gas or natural gas serving as a fuel for power generation, or for use in pressure vessels for storing oxygen gas , for example, in the automobile industry, housing industry, military industry, aerospace industry, medical industry, etc. and to a process for producing the liner.

The term “aluminum” as used herein and in the appended claims includes aluminum alloys in addition to pure aluminum.

### BACKGROUND ART

In order to control air pollution, efforts have been made in recent years for developing natural gas motor vehicles and fuel cell motor vehicles which produce clean emissions. These motor vehicles have installed therein a pressure vessel filled with fuel natural gas or hydrogen gas to a high pressure, and it is desired to fill the vessel with the gas to a further higher pressure for driving over increased distances.

A liner is already known for use in such high-pressure vessels. The known liner comprises a tubular trunk and a pair of head plates for closing opposite end openings of the trunk. The liner comprises a trunk made of an aluminum extrudate and in the form of a hollow cylindrical body having opposite open ends, and two head plates each in the form of a dome, made from aluminum by die casting and welded respectively to opposite ends of the trunk. The trunk has joined to the inner surface thereof a plurality of reinforcing walls which are radial in cross section. Each head plate has reinforcing walls joined to the inner surface thereof and positioned in corresponding relation with the reinforcing walls of the trunk (see, for example, the publication of JP-A No. 9-42595).

For use as a pressure vessel, the liner has a helical winding reinforcing layer formed by winding reinforcing fibers around the trunk longitudinally thereof and partly around the two head plates to obtain a helical winding fiber layer, impregnating the fiber layer with an epoxy resin and curing the resin, and a hooped reinforcing layer made by winding reinforcing fibers around the trunk circumferentially thereof to obtain a hoped fiber layer, impregnating the fiber layer with an epoxy resin and curing the resin.

The pressure vessel liner disclosed in the above publication has a satisfactory pressure resistant strength afforded by the function of the reinforcing walls against radial forces. However, if the liner is subjected to a great force longitudinally thereof, stress acts concentrically on the weld joint of the trunk and the head plate, possibly fracturing the liner at the joint portion because the reinforcing walls of the trunk are not joined to those of the head plate. To prevent such a fracture, there is a need to give an increased thickness to the helical winding reinforcing layer of the pressure vessel, which therefore has the problem of being greater in weight. Further in forming the helical winding fiber layer, fibers are likely to become broken by sliding contact or by being caught, consequently failing to afford the required pressure resistance.

An object of the present invention is to overcome the above problem and to provide a liner for pressure vessels which has an increased pressure resistant strength against longitudinal forces and a process for producing the liner.

### DISCLOSURE OF THE INVENTION

To fulfill the above object, the present invention comprises the following modes.

1) A pressure vessel liner comprising a tubular trunk and head plates for closing respective opposite end openings of the trunk, the trunk having a reinforcing member fixedly provided therein and extending longitudinally of the trunk for dividing interior of the trunk into a plurality of spaces, the head plates being joined to the reinforcing member.

2) A pressure vessel liner according to par. 1) wherein the combined length of joints between each of the head plates and the reinforcing member is at least 60% of the combined length of portions of the reinforcing member in contact with an inner surface of the head plate.

3) A pressure vessel liner according to par. 1) wherein the head plates are joined to the reinforcing member by friction agitation.

4) A pressure vessel liner according to par. 1) wherein the head plates are formed separately from the trunk and are joined respectively to opposite ends of the trunk.

5) A pressure vessel liner according to par. 1) wherein one of the head plates is formed integrally with one end of the trunk and the other head plate is formed separately from the trunk and joined to the other end of the trunk.

6) A pressure vessel liner according to par. 1) wherein at least one of the head plates is in the form of an outwardly bulging dome, and an end portion of the reinforcing member adjacent to the domelike head plate projects outward beyond the trunk and fitted in the domelike head plate.

7) A pressure vessel liner according to par. 1) wherein at least one of the head plates has a flat inner surface.

8) A process for fabricating a pressure vessel liner according to par. 1) including extruding a tubular trunk having opposite open ends and a reinforcing member extending longitudinally of the trunk and forming two head plates, inserting the reinforcing member into the trunk and joining the trunk to the reinforcing member, and joining the two head plates respectively to the opposite ends of the trunk and joining the two head plates to the reinforcing member.

9) A process for fabricating a pressure vessel liner according to par. 8) wherein the trunk is joined to the reinforcing member by friction agitation from outside the trunk.

10) A process for fabricating a pressure vessel liner according to par. 8) wherein one of the head plates is formed by forging and an outwardly extending projection is formed on an outer surface of said one head plate integrally therewith when said one head plate is formed by forging, and which includes providing a mouthpiece portion by forming a through bore extending from an outer end face of the projection to an inner surface of said one head plate after joining the two head plates respectively to the opposite ends of the trunk and joining the two head plates to the reinforcing member.

11) A process for fabricating a pressure vessel liner according to par. 8) wherein the head plates are joined to the reinforcing member by friction agitation from outside the head plates.

12) A process for fabricating a pressure vessel liner according to par. 1) including extruding a tubular trunk having opposite open ends and a reinforcing member extending longitudinally of the trunk and dividing interior of the trunk into a plurality of spaces in the form of an integral assembly and forming two head plates, and joining the two head plates respectively to the opposite ends of the trunk and joining the two head plates to the reinforcing member.

13) A process for fabricating a pressure vessel liner according to par. 12) wherein one of the head plates is formed by forging and an outwardly extending projection is formed on an outer surface of said one head plate integrally therewith when said one head plate is formed by forging, and which includes providing a mouthpiece portion by forming a through bore extending from an outer end face of the projection to an inner surface of said one head plate after joining the two head plates respectively to the opposite ends of the trunk and joining the two head plates to the reinforcing member.

14) A process for fabricating a pressure vessel liner according to par. 12) wherein the head plates are joined to the reinforcing member by friction agitation from outside the head plates.

15) A process for fabricating a pressure vessel liner according to par. 1) including forming a tubular trunk having opposite open ends and a head plate for closing one of the open ends of the trunk by forging in the form of an integral assembly, forming a head plate for closing the other open end of the trunk, extruding a reinforcing member extending longitudinally of the trunk, inserting the reinforcing member into the trunk and joining the trunk to the reinforcing member, and joining the head plate formed separately from the trunk to the other end of the trunk and joining the two head plates to the reinforcing member.

16) A process for fabricating a pressure vessel liner according to par. 15) wherein when the integral assembly of the trunk and the head plate is formed by forging, an outwardly extending projection is formed on an outer surface of the head plate integrally therewith, and which includes providing a mouthpiece portion by forming a through bore extending from an outer end face of the projection to an inner surface of the head plate after joining the head plate formed separately from the trunk to the other end of the trunk and joining the two head plates to the reinforcing member.

17) A process for fabricating a pressure vessel liner according to par. 15) wherein the head plate for closing the other open end of the trunk is formed by forging, and an outwardly extending projection is integrally formed on an outer surface of the head plate to be formed by forging, and which includes providing a mouthpiece portion by forming a through bore extending from an outer end face of the projection to an inner surface of the head plate after joining the head plate formed separately from the trunk to the other end of the trunk and joining the two head plates to the reinforcing member.

18) A process for fabricating a pressure vessel liner according to par. 15) wherein the trunk is joined to the reinforcing member by friction agitation from outside the trunk.

19) A process for fabricating a pressure vessel liner according to par. 15) wherein the head plates are joined to the reinforcing member by friction agitation from outside the head plates.

20) A pressure vessel comprising a pressure vessel liner according to any one of pars. 1) to 7) which is covered with a fiber reinforced resin layer over an outer peripheral surface thereof.

21) A fuel cell system comprising a fuel hydrogen pressure vessel, a fuel cell and pressure piping for delivering fuel hydrogen gas from the pressure vessel to the fuel cell therethrough, the fuel hydrogen pressure vessel comprising a pressure vessel according to par. 20).

22) A fuel cell motor vehicle having installed therein a fuel cell system according to par. 21).

23) A cogeneration system comprising a fuel cell system according to par. 21).

24) A natural gas supply system comprising a natural gas pressure vessel and pressure piping for delivering natural gas from the pressure vessel therethrough, the natural gas pressure vessel being a pressure vessel according to par. 20).

25) A cogeneration system comprising a natural gas supply system according to par. 24), a generator and a generator drive device.

26) A natural gas motor vehicle comprising a natural gas supply system according to par. 24) and an engine for use with natural gas as a fuel.

With the pressure vessel liner described in pars 1) to 7), the reinforcing member fixedly provided in the trunk is joined to the two head plates. This arrangement gives an enhanced pressure resistant strength to the liner against longitudinal forces. When the liner is used in pressure vessels, the helical winding fiber layer can be smaller in thickness, or the helical winding fiber layer can be dispensed with, consequently affording a high-pressure vessel of reduced weight. Moreover, the construction results in improved productivity and a reduced production cost.

Further when a gas of high pressure, such as hydrogen gas or natural gas, has an increased temperature when filled into the pressure vessel liner, the heat of the gas is transferred to the reinforcing member and dissipated to the outside from the reinforcing member through the trunk and the head plates, consequently reducing the rise in the temperature of the gas and permitting an increased amount of gas to be filled into the vessel to ensure an improved filling efficiency.

The pressure vessel liner described in par. 2) has a reliably enhanced pressure resistant strength against longitudinal forces.

The pressure vessel liner according to par. 7) can be of an increased capacity relative to the entire length of the liner.

The process described in pars. 8) to 19) makes it possible to fabricate a pressure vessel liner described in par. 1) relatively easily.

The pressure vessel liner fabrication process according to par. 13) makes it possible to relatively shorten the length of projection of the mouthpiece portion from the head plate. The mouthpiece portion usually has a threaded through bore for fitting a valve thereinto in screw-thread engagement therewith, and the threaded inner peripheral surface defining the bore needs to be in the form of cylindrical surface. The internally threaded portion can be formed over the entire length of the bore-defining inner peripheral surface by the process described in par. 13), with the result that the length of projection of the mouthpiece portion from the head plate can be made relatively smaller.

The pressure vessel fabrication process described in pars. 16) and 17) serves to relatively shorten the length of projection of the mouthpiece from the head plate as in the case of the process described in par. 13).

### BRIEF DESCRIPTION OF THE DRAWINGS

FIG. 1 is a perspective view showing a pressure vessel liner of Embodiment 1 of the invention. FIG. 2 is a view in longitudinal section of a high-pressure vessel comprising the pressure vessel liner of FIG. 1. FIG. 3 is a perspective view of a blank for use in making a trunk and a reinforcing member of the pressure vessel liner of FIG. 1. FIG. 4 is a perspective view showing the trunk, two head plates and the reinforcing member for use in fabricating the pressure vessel liner of FIG. 1. FIG. 5 is a fragmentary perspective view showing how to join the head plate to the reinforcing member in a process for fabricating the pressure vessel liner of FIG. 1. FIG. 6 is an enlarged fragmentary views in section showing how to join the head plate to the reinforcing member in the process for fabricating the pressure vessel liner of FIG. 1. FIG. 7 is a fragmentary perspective view showing one of the head plates as joined to the reinforcing member in the process for fabricating the pressure vessel liner of FIG. 1. FIG. 8 is a fragmentary perspective view showing the other head plate as joined to the reinforcing member in the process for fabricating the pressure vessel liner of FIG. 1. FIG. 9 is an enlarged fragmentary views in section showing how to join the trunk to the head plate in the process for fabricating the pressure vessel liner of FIG. 1. FIG. 10 is a perspective view showing a pressure vessel liner of Embodiment 2 of the invention. FIG. 11 is a view in longitudinal section showing a high-pressure vessel comprising the pressure vessel liner of FIG. 10. FIG. 12 is a perspective view of one of head plates for use in fabricating the pressure vessel liner of FIG. 10. FIG. 13 is a fragmentary perspective view showing how to join one of the head plates to a reinforcing member in the process for fabricating the pressure vessel liner of FIG. 10. FIG. 14 is a fragmentary perspective view showing one of the head plates as joined to the reinforcing member in the process for fabricating the pressure vessel liner of FIG. 10. FIG. 15 is a fragmentary perspective view showing a modified method of joining one of the head plates to the reinforcing member in the process for fabricating the pressure vessel liner of FIG. 10. FIG. 16 is a perspective view showing a pressure vessel liner of Embodiment 3 of the invention. FIG. 17 is a perspective view showing a trunk, one of head plates, the other head plate and a reinforcing member for use in fabricating the pressure vessel liner of FIG. 16. FIG. 18 is a perspective view showing a pressure vessel liner of Embodiment 4 of the invention. FIG. 19 is a view in longitudinal section of a high-pressure vessel comprising the pressure vessel liner of FIG. 18. FIG. 20 is a perspective view showing a trunk, a reinforcing member and two head plates for use in fabricating the pressure vessel liner of Embodiment 4 of the invention.

### BEST MODE OF CARRYING OUT THE INVENTION

Embodiments of the invention will be described below with reference to the drawings. Throughout the drawings, like parts will be designated by like reference numerals and will not be described repeatedly.

### EMBODIMENT 1

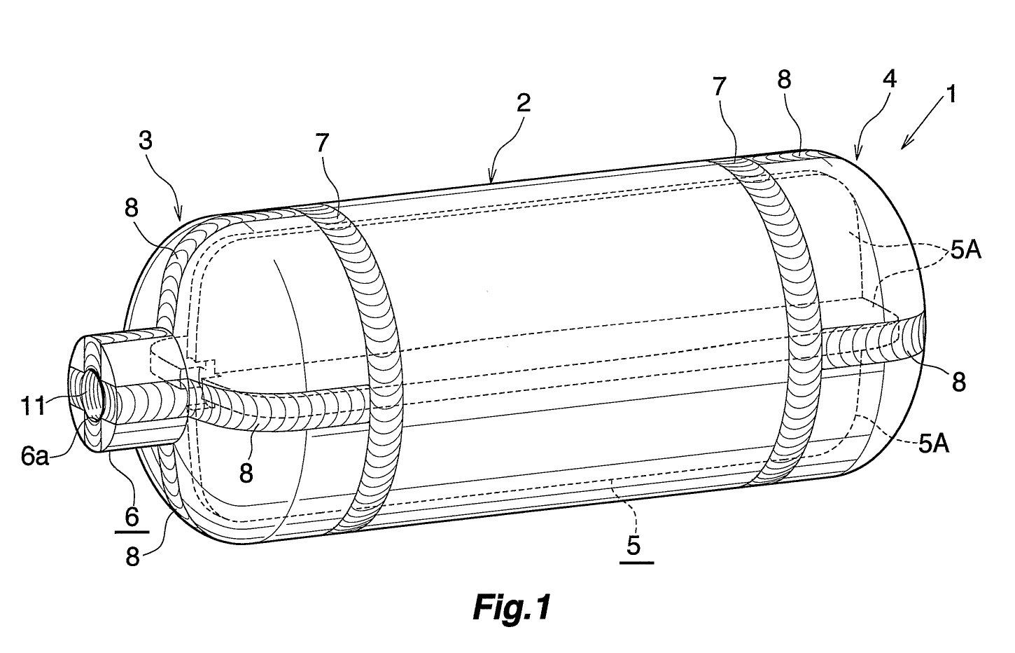

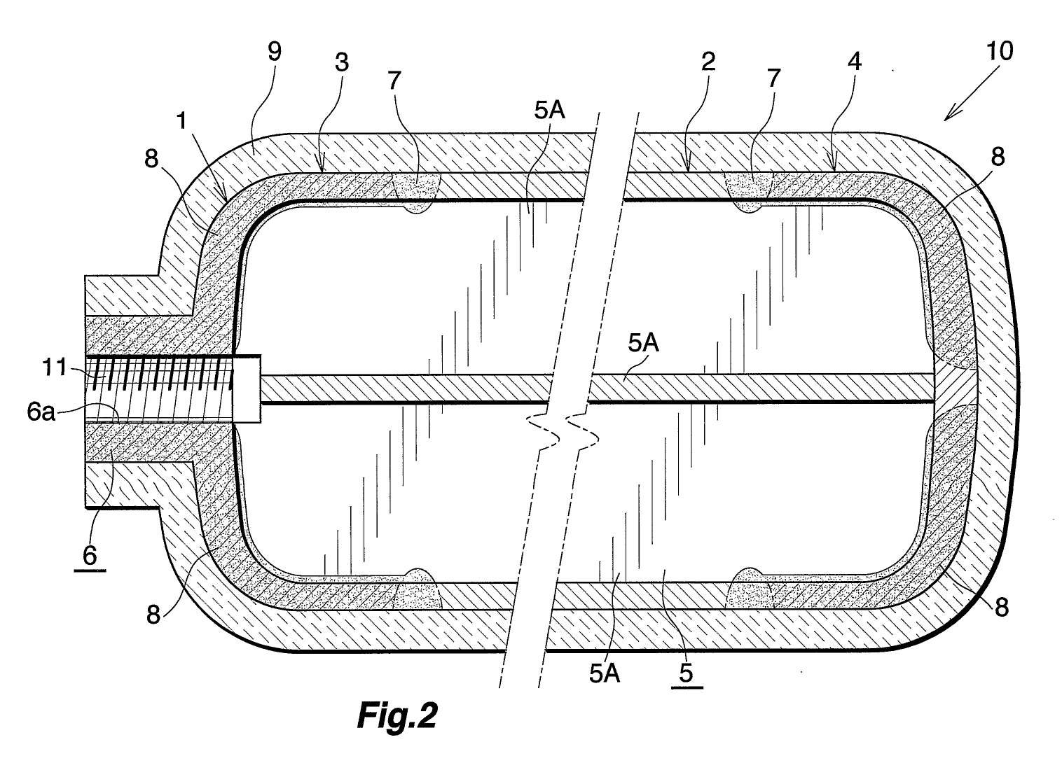

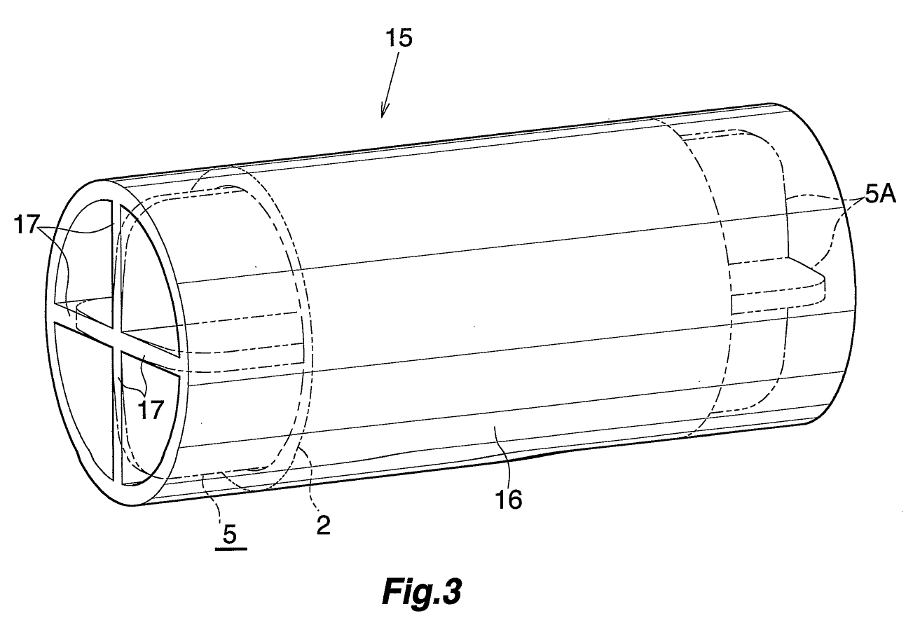

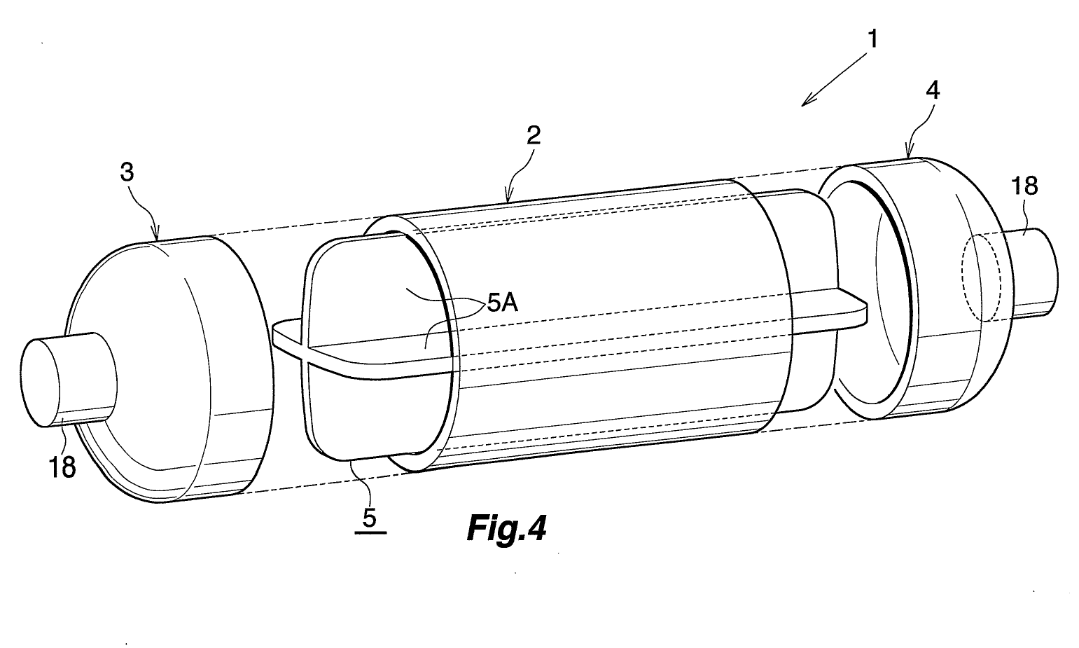

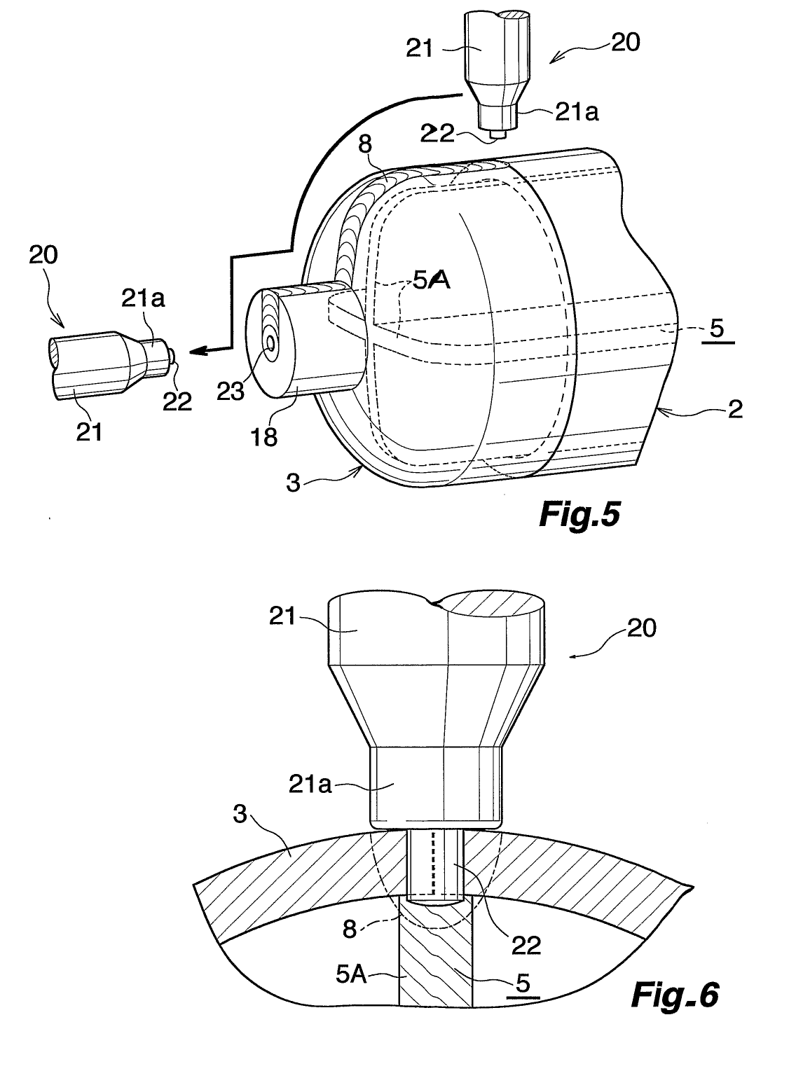

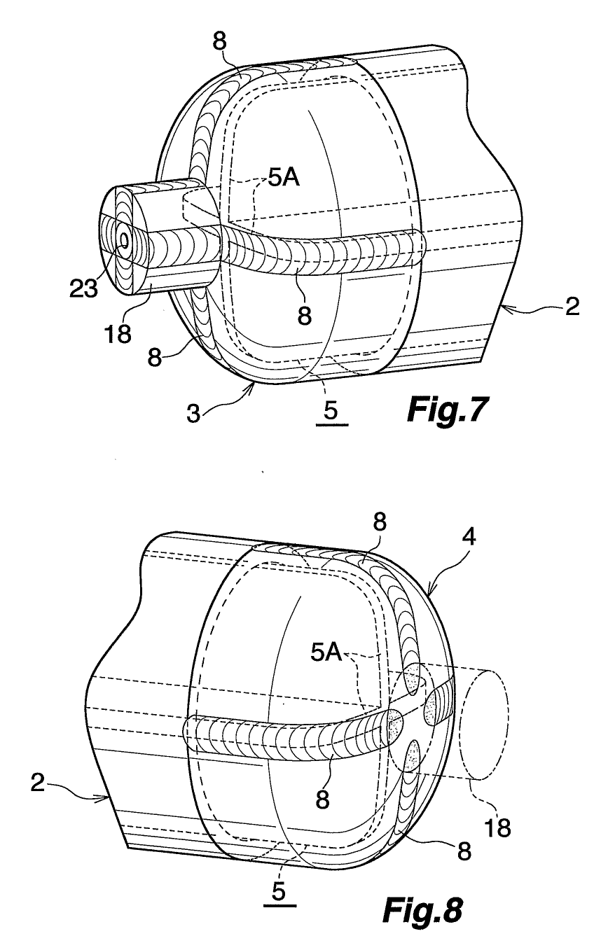

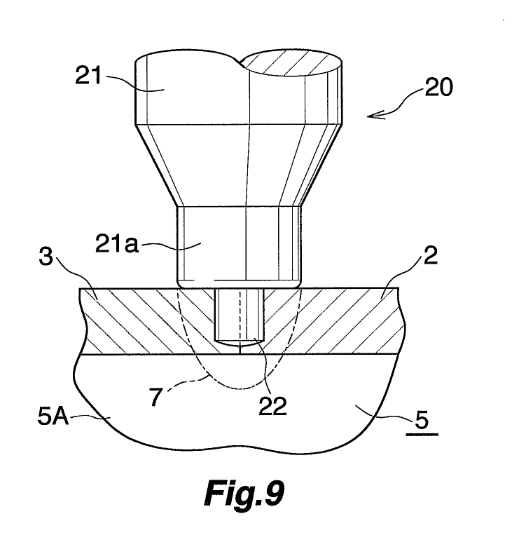

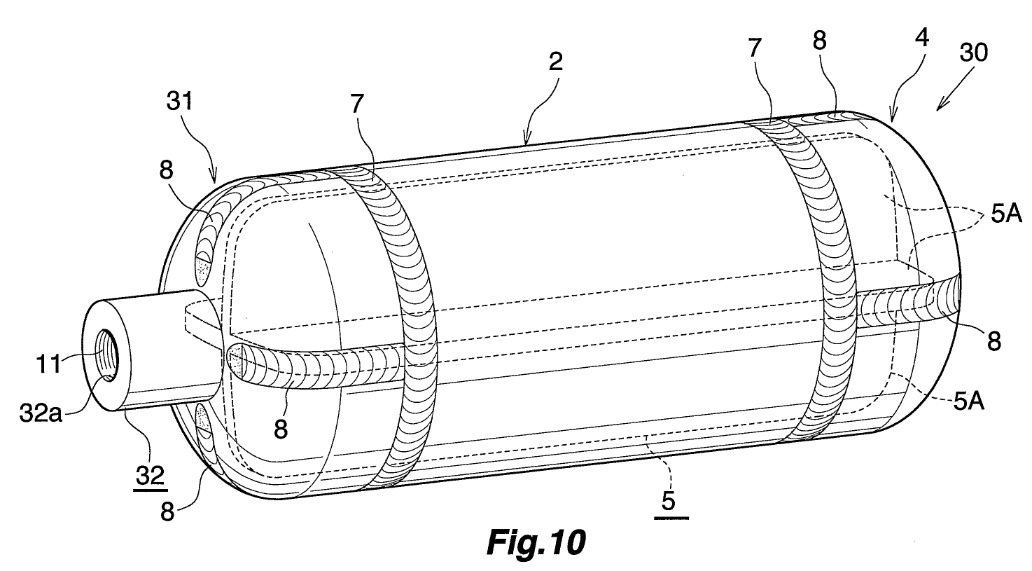

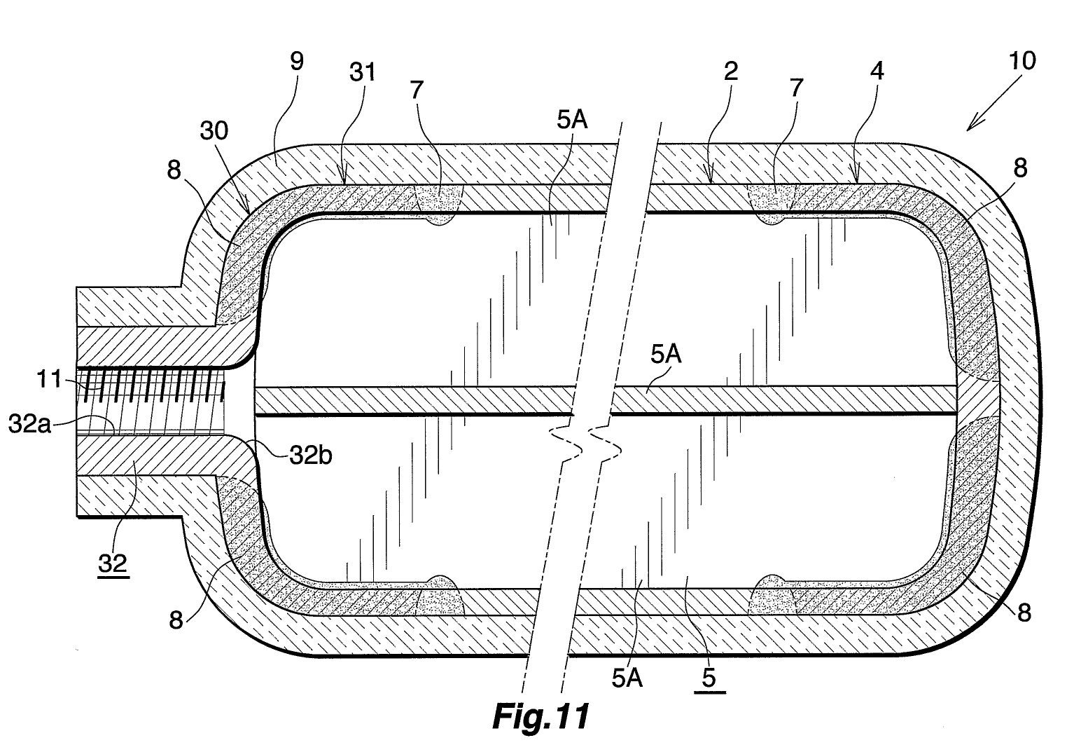

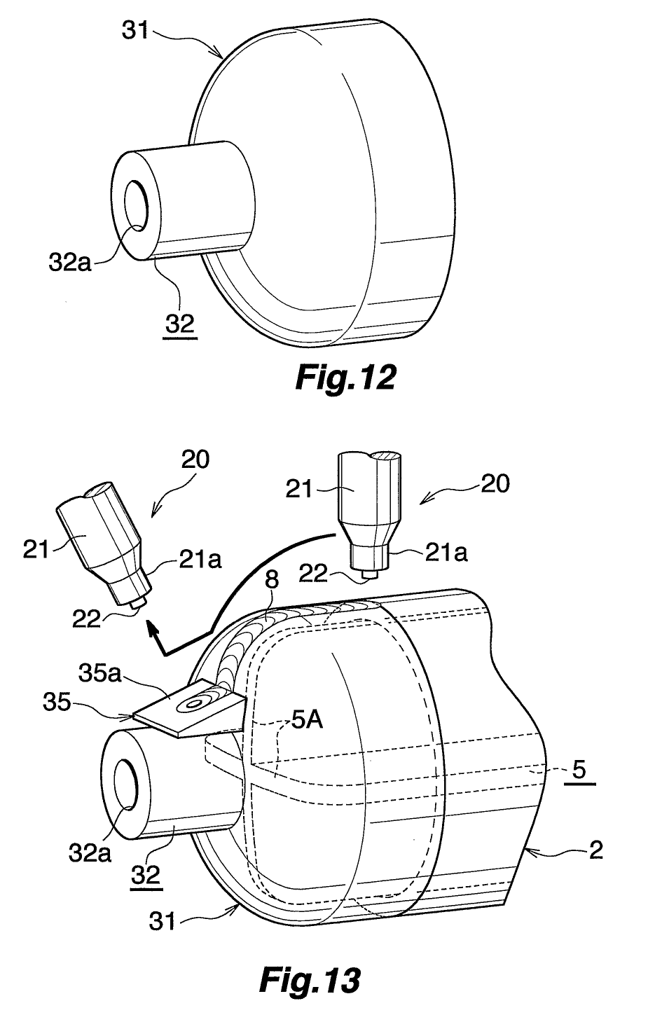

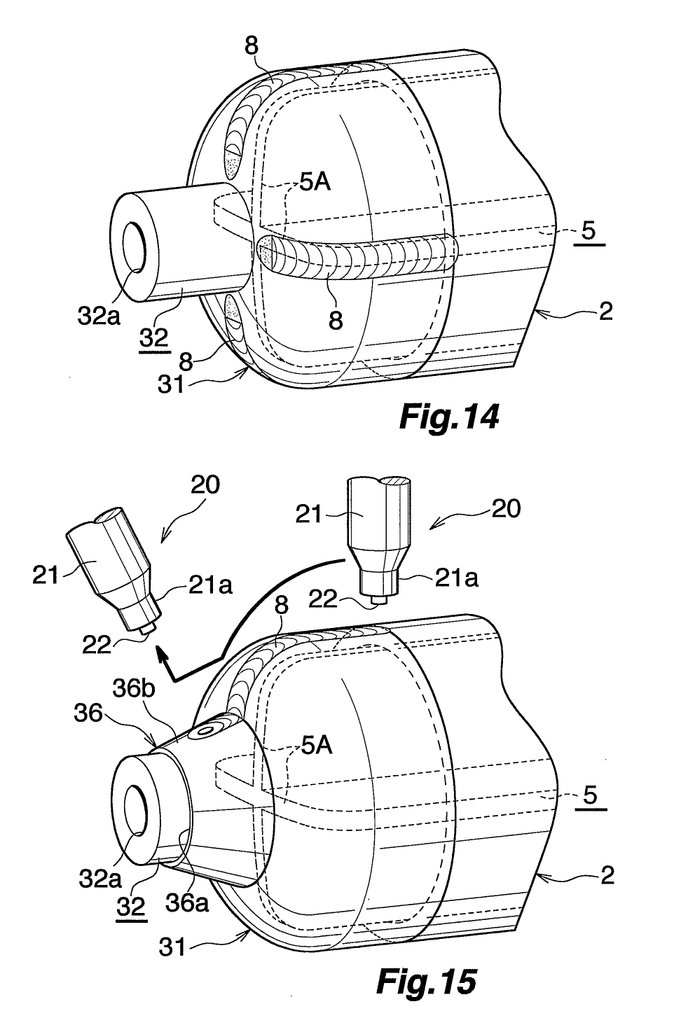

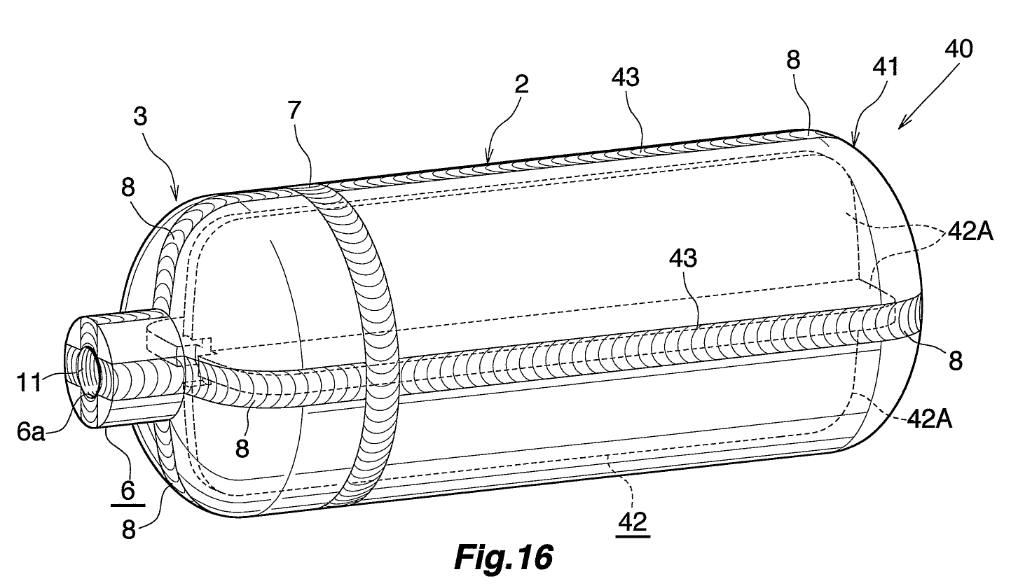

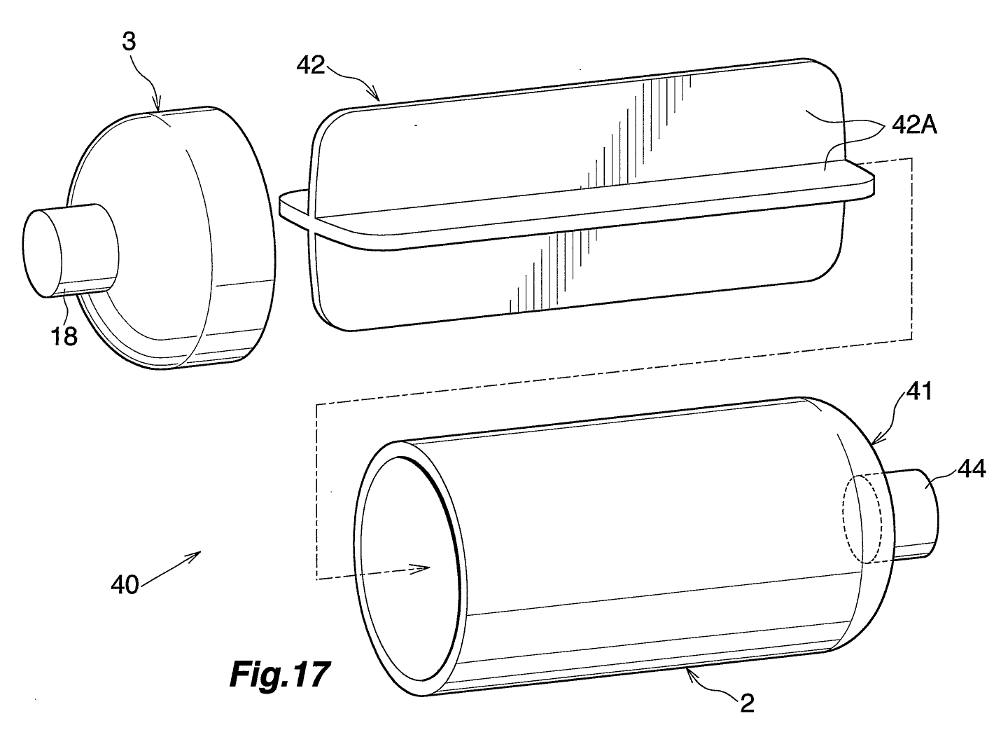

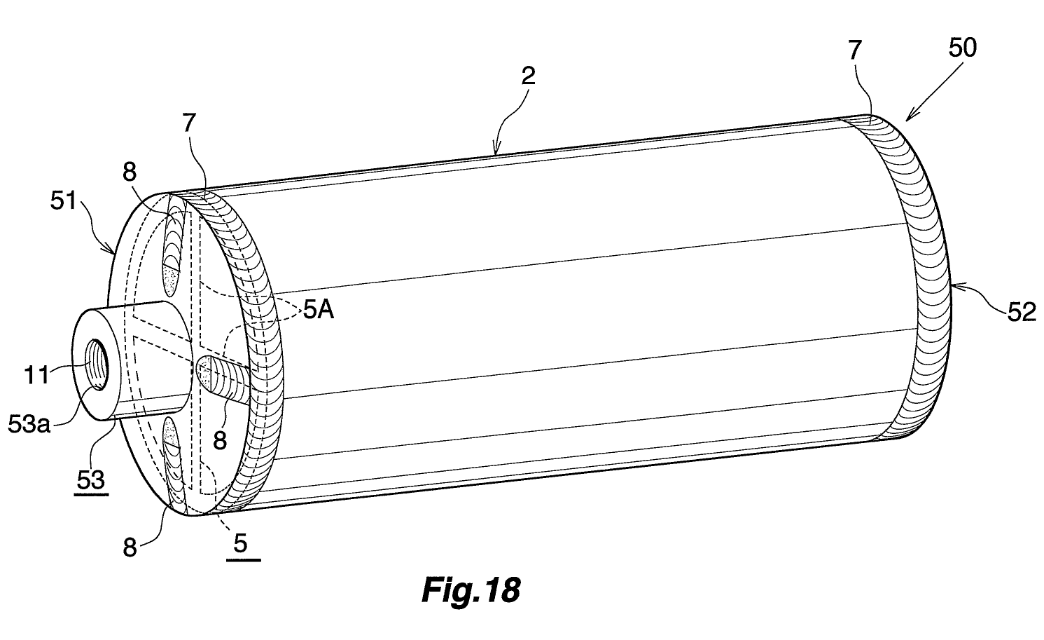

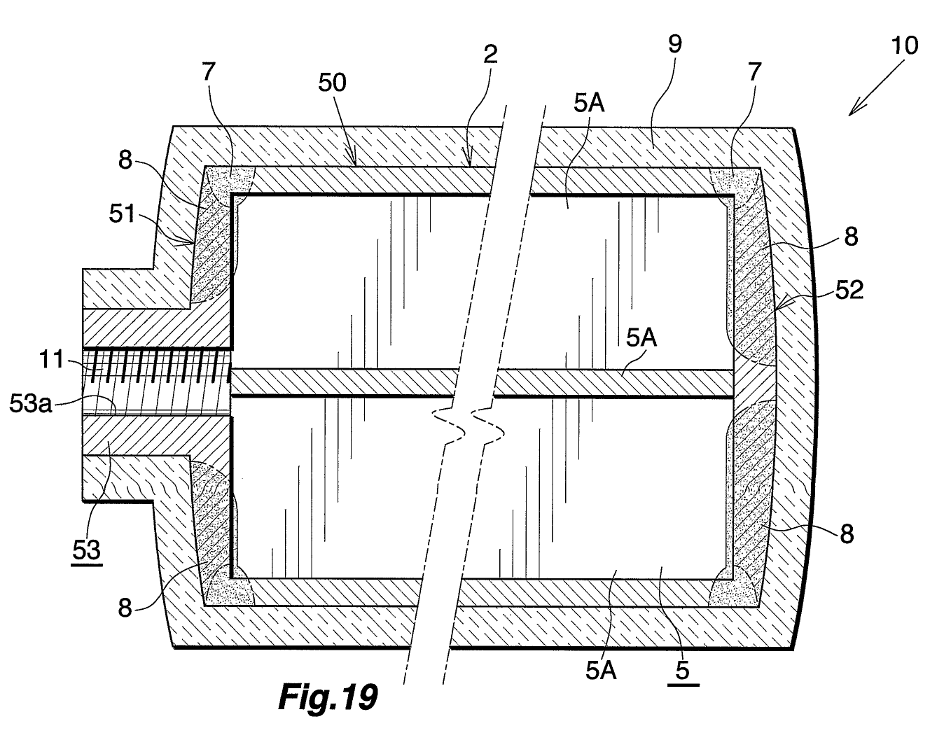

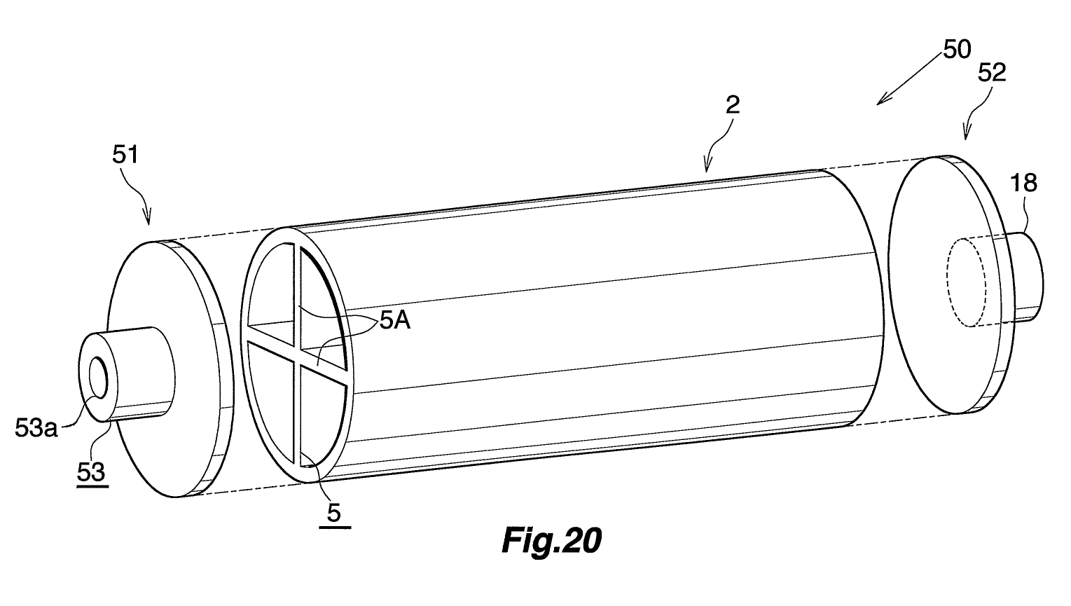

This embodiment is shown in FIGS. 1 to 9.

FIG. 1 shows a pressure vessel liner of this embodiment. FIG. 2 shows a pressure vessel for high-pressure hydrogen gas wherein the liner is used. FIGS. 3 to 9 show a process for fabricating the pressure vessel liner.

With reference to FIG. 1, a pressure vessel liner 1 comprises an aluminum trunk 2 which is open at opposite ends thereof, and aluminum head plates 3, 4 each in the form of an outwardly bulging dome for closing the respective end openings.

The trunk 2 is internally provided with a reinforcing member 5 integral therewith and extending longitudinally thereof for dividing the interior of the trunk 2 into a plurality of spaces. The trunk 2 and the reinforcing member 5 are integrally extruded using one of JIS A2000 alloy, JIS A5000 alloy, JIS A60000 alloy and JIS A7000 alloy. The reinforcing member 5 comprises a plurality of, i.e., four, reinforcing walls 5A extending from the inner peripheral surface of the trunk 2 toward the center line of the trunk 2 and joined to one another on the center line. According to the embodiment, all the reinforcing walls 5A are spaced at equal angles about the center line of the trunk 5. According to Embodiment 1, however, the number of reinforcing walls 5A and the angular spacing between each adjacent pair of reinforcing walls 5A about the center line are not limited to those described above. The interior of the trunk 2 is divided by the reinforcing walls 5A into spaces equal in number to the number of walls 5A and having open opposite ends. The reinforcing member 5 has opposite ends projecting outward beyond the opposite end openings of the trunk 2 and fitting in the respective domelike head plates 3, 4.

One of the head plates, 3, is provided with a mouthpiece portion 6 having a through bore 6a for holding the interior of the liner 1 in communication with outside therethrough. The inner periphery of the mouthpiece portion 6 defining the bore 6a is in the form of a cylindrical surface over the entire length thereof and is threaded as at 11 (see FIG. 2). The two head plates 3, 4 are made from one of JIS A2000 alloy, JIS A5000 alloy, JIS A60000 alloy and JIS A7000 alloy by forging.

The trunk 2 and each of the head plates 3, 4 are butted against each other, and the butted portions are joined by friction agitation from outside over the entire circumference thereof. The joint has beads 7. The opposite ends of the reinforcing member 5 are in bearing contact with the inner surfaces of the respective head plates 3, 4, and the reinforcing walls 5A are joined to the head plates 3, 4 from outside the head plates 3, 4 by friction agitation. The joints have beads 8. The combined length of the joints between each of the head plates 3, 4 and the reinforcing member 5 is preferably at least 60% of the combined length of the portions of the reinforcing member 5 in contact with the inner surface of the head plate 3 or 4.

With reference to FIG. 2, the pressure vessel liner 1 is entirely covered with a fiber reinforced resin layer 9, for example, of carbon fiber reinforced resin for use as a high-pressure vessel 10. As in the pressure vessel liner disclosed in above-mentioned publication, the fiber reinforced resin layer 9 comprises a helical winding reinforcing layer formed by winding reinforcing fibers around the trunk 2 longitudinally thereof and partly around the two head plates 3, 4, a hooped reinforcing layer made by winding reinforcing fibers around the trunk 2 circumferentially thereof and a resin impregnating these reinforcing layers and cured. The resin to be used is a thermosetting resin or photosetting resin. The hooped reinforcing layer is not always necessary.

The pressure vessel liner 1 is fabricated by the process to be described below with reference to FIGS. 3 to 9.

Using an extruder (not shown) having a porthole die, first produced by extrusion is an integral blank 15 comprising a hollow cylindrical trunk forming portion 16 and a plurality of, i.e., four, reinforcing walls 17, the reinforcing walls 17 extending from the inner peripheral surface of the trunk forming portion 16 toward the center line of the trunk and joined to one another on the center line as shown in FIG. 3. The blank 15 is the same as the trunk 2 and the reinforcing member 5 in cross sectional shape. Subsequently, an integral assembly of trunk 2 and reinforcing member 5 is made by cutting off opposite end portions of the trunk forming portion 16 and shaping opposite end portions of the reinforcing walls 17 in conformity with the shape of the inner surface of two head plates 3, 4 by cutting (see chain lines in FIG. 3). Further two head plates 3, 4 are made each by forging. At this time, a solid cylindrical projection 18 is formed integrally on the outer surface of each of the head plates 3, 4 centrally thereof (see FIG. 4). The two head plates 3, 4 are identical in shape and are produced using the same die.

The head plates 3, 4 are then fitted around the portions of the reinforcing member 5 projecting beyond the respective ends of the trunk 2, the end faces of the head plates 3, 4 are butted against the respective end faces of the trunk 2, and opposite ends of the reinforcing member 5 are brought into bearing contact with the head plates 3, 4.

Subsequently, the opposite ends of the reinforcing member 5 are joined to the head plates 3, 4 by friction agitation. First prepared is a friction agitation joining tool 20 comprising a solid cylindrical rotor 21 having a small-diameter portion 21a provided integrally therewith at a forward end thereof and extending from the rotor axially thereof with a tapered portion provided therebetween, and a pinlike probe 22 extending from the end of the rotor small-diameter portion 21a axially thereof and integrally therewith and having a smaller diameter than the portion 21a (see FIG. 5). The rotor 21 and the probe 22 are made of a material harder than the trunk 2 and the head plates 3, 4 and having heat resistance to withstand the frictional heat to be produced during joining.

While rotating the tool 20, the probe 22 is thereafter placed into one of the head plates, 3, from outside at an end portion thereof adjacent to the trunk 2 and at a position corresponding to one of the reinforcing walls 5A of the reinforcing member 5, with the shoulder part of the small-diameter portion 21a around the probe 22 pressed against the outer surface of the head plate 3. The probe 22 is given such a length that the outer end of the probe 22 placed in will be positioned in the reinforcing wall 5A at this time (see FIG. 6). A softened portion that will be produced at the start of and during joining can be prevented from scattering the metal material thereof, and the resulting joint can be precluded from forming burrs or like surface irregularities, by the shoulder part pressed against the head plate.

Subsequently, the work of trunk 2 and head plate 3, and the friction agitation joining tool 20 are moved relative to each other to thereby move the probe 22 toward the projection 18. This generates frictional heat by the rotation of the probe 22 to soften the base material metal of the head plate 3 and the reinforcing wall 5A, and the softened portion is agitated and mixed by being subjected to the rotational force of the probe 22, further plastically flows to fill up a groove left by the passage of the probe 22 and thereafter rapidly loses the frictional heat to solidify on cooling. These phenomena are repeated with the movement of the probe 22 to progressively join the head plate 3 to the reinforcing wall 5A and form beads 8. The probe 22 is further moved through the periphery of the projection 18 to the outer end face thereof and is withdrawn from the projection at the center of the end face. A bore 23 is formed in the center of end face of the projection 18 by the withdrawal of the probe 22 (see FIG. 5). Such a procedure is repeated for all the reinforcing walls 5A to join the head plate 3 to the reinforcing member 5 (see FIG. 7). The probe withdrawal bore 23 is formed in common when the head plate is joined to all the reinforcing walls 5A (see FIG. 7). The other head plate 4 is also joined to the reinforcing member 5 in the same manner as above.

Thereafter made in the projection 18 of the head plate 3 is a through bore 6a extending from the outer end face thereof to the inner surface of the head plate 3, and the through bore 6a is internally threaded as at 11, The projection is further cut off from the other head plate 4 (see FIG. 8).

Subsequently, while being rotated, the friction agitation joining tool 20 has its probe 22 placed from outside into the butted joint of the trunk 2 and the head plate 3 at a position along the circumferential direction, with the shoulder part of the small-diameter portion 21a of the tool 20 around the probe 22 pressed against the trunk 2 and the head plate 3 (see FIG. 9). The probe 22 has such a length the forward end of the probe 22 is positioned at this time preferably at a distance of at least 0.1 mm to not greater than ½ of the wall thickness of the trunk 2 and the head plates 3, 4, from the inner peripheral surfaces of the trunk 2 and the head plates 3, 4. If this distance is less than 0.1 mm, it is likely that a V-shaped groove will be formed in the inner peripheral surfaces of the trunk 2 and the head plate 3 circumferentially thereof during the frictional agitation joining by the probe 22 to be described later, failing to give satisfactory pressure resistance. Alternatively if the distance is in excess of ½ of the wall thickness of the trunk 2 and the head plate 3, the portions to be joined of the trunk 2 and the head plate 3 become smaller in thickness relative to the entire thickness of the trunk 2 and the head plate 3 to similarly entail the likelihood that sufficient pressure resistance will not be available. Although the material of a softened portion is likely to scatter at the start of and during joining, the shoulder part of the small-diameter portion 21a in pressing contact with the trunk and the head plate produces a satisfactory joint by preventing such trouble, further generating frictional heat by the sliding movement of the shoulder part on the trunk 2 and the head plate 3 and softening the portions of the trunk 2 and the head plate in contact with the shoulder part and the vicinity thereof to a greater extent while preventing formation of burrs or like irregularities on the surface of the joint.

The work of trunk 2 and the head plate 3, and the friction agitation joining tool 20 are then moved relative to each other to move the probe 22 along the butted joint circumferentially thereof. The frictional heat generated by the rotation of the probe 22 and the frictional heat generated by the sliding movement of the shoulder part on the trunk 2 and the head plate 3 soften the base material metal of the trunk 2 and the head plate 3 in the vicinity of the butted joint, and the softened portion is agitated and mixed by being subjected to the rotational force of the probe 22, further plastically flows to fill up a groove left by the passage of the probe 22 and thereafter rapidly loses the frictional heat to solidify on cooling. These phenomena are repeated with the movement of the probe 22 to join the trunk 2 and the head plate 3. Upon the return of the probe 22 to the initial position after moving along the butted joint over the entire circumference, the trunk 2 and the head plate 3 are joined over the entire circumference. Beads 7 are formed at this time.

After the probe 22 is returned to the initial position where it is placed into the butted joint or after the probe 22 is moved past this position, the probe 22 is moved to the location of a contact member (not shown) disposed at the butted joint of the trunk 2 and the head plate 3, where the probe 22 is withdrawn. In the same manner as above, the other head plate 4 is also joined to the trunk 2 by friction agitation. In this way, the pressure vessel liner 1 is fabricated.

### EMBODIMENT 2

This embodiment is shown in FIGS. 10 to 15.

In the case of a pressure vessel liner 30 of this embodiment, a mouthpiece portion 32 is provided on one of head plates, 31, and has an inner peripheral surface defining a bore 32a extending through the mouthpiece portion 32. The joint of the inner peripheral surface and the inner surface of the head plate 31 is rounded (see FIG. 11). The mouthpiece portion 32 is internally threaded as at 11 except at the rounded portion 32b. The internally threaded portion 11 has a length equal to the entire length of the through bore 6a of Embodiment 1. With the exception of this feature, the liner 30 of this embodiment is the same as the pressure vessel liner 1 of Embodiment 1 described.

As shown in FIG. 11, the pressure vessel liner 30 of Embodiment 2 is entirely covered with a fiber reinforced resin layer 9, for example, of carbon fiber reinforced resin for use as a high-pressure vessel 10. As in the pressure vessel liner disclosed in above-mentioned publication, the fiber reinforced resin layer 9 comprises a helical winding reinforcing layer formed by winding reinforcing fibers around the trunk 2 longitudinally thereof and partly around the two head plates 31, 4, a hooped reinforcing layer made by winding reinforcing fibers around the trunk 2 circumferentially thereof and a resin impregnating these reinforcing layers and cured. The resin to be used is a thermosetting resin or photosetting resin. The hooped reinforcing layer is not always necessary.

Next, a description will be given of only the differences of the process for fabricating the pressure vessel liner 30 of Embodiment 2 from the process for fabricating the pressure vessel liner 1 of Embodiment 1.

In making one of the head plates, 31, by forging, a mouthpiece portion 32 having a through bore 32a is formed integrally therewith (see FIG. 12). Accordingly, a rounded portion 32b is formed at the joint between the inner peripheral surface of the portion 32 defining the bore 32a and the inner surface of the head plate 31. Further in joining the head plate 31 to the reinforcing wall 5A of the reinforcing member 5 by friction agitation, the probe 22 is withdrawn using a contact member 35 as shown in FIG. 13. The contact member 35 is in the form of a right-angled triangle in section, and is positioned with the two sides making a right angle with each other in contact with the outer surface of the head plate 31 and the peripheral surface of the mouthpiece portion 32 so that the slope 35a will face outward. The probe 22 is moved to the slope 35a of the contact member 35 and then withdrawn. No beads 7 on the outer surface of the head plate 31 are therefore formed on the mouthpiece portion 32 (see FIG. 14).

Further when joining the head plate 31 to the reinforcing wall 5A of the reinforcing member 5 by friction agitation, the probe 22 may be withdrawn using a frustoconical contact member 36 as shown in FIG. 15. The contact member 36 has a hole 36a for inserting the mouthpiece portion 32 therethrough, and is positioned with the mouth piece portion 32 inserted through the hole 36a.

In joining the head plate 31 to the reinforcing wall 5A of the reinforcing member 5 by friction agitation, the probe 22 is moved to the frustoconical peripheral surface 36b of the contact member 36 and then withdrawn. The head plate 31 can be joined to all the reinforcing walls 5A by friction agitation using only one contact member 36.

### EMBODIMENT 3

This embodiment is shown in FIGS. 16 and 17.

A pressure vessel liner 40 of this embodiment has the same construction as the pressure vessel liner 1 of Embodiment 1 except that a head plate 41 having no mouthpiece portion 6 is provided integrally with a trunk 2 in the form of an outwardly bulging dome, and that a reinforcing member 42 comprising a plurality of reinforcing walls 42A and identical with the reinforcing member 5 of Embodiment 1 in shape is made separately from the trunk 2, placed into the trunk 2 and joined to the trunk 2 by friction agitation. The joints of the trunk 2 and the reinforcing walls 42A of the reinforcing member 42 have beads 43. The length of joining of the trunk 2 to the reinforcing member 42 is preferably at least 60% of the entire length of the reinforcing member 42, and the reinforcing member 42 is joined to the trunk 2 by friction agitation over the entire length of the trunk 2 according to this embodiment.

Although not shown, the pressure vessel liner 40 is entirely covered with a fiber reinforced resin layer, for example, of carbon fiber reinforced resin for use as a high-pressure vessel. The fiber reinforced resin layer has the same construction as in Embodiments 1 and 2 described.

The pressure vessel liner is fabricated by the process to be described next.

A trunk 2 and a head plate 41 are made integrally by forging as shown in FIG. 17. A solid cylindrical projection 41 projecting outward is formed integrally on the outer surface of the head plate 41 centrally thereof. A reinforcing member 42 is made by extrusion, and opposite end portions thereof are shaped by cutting so as to fit to the respective inner surfaces of two head plates 3, 41 in bearing contact therewith. The head plate 3 having a projection 18 is made by forging.

The reinforcing member 42 is then placed into the trunk 2 with one end thereof brought into bearing contact with the inner surface of the head plate 41. While rotating the friction agitation joining tool 20, the probe 22 is thereafter placed from outside into an open end portion of the trunk 2 at a position corresponding to one reinforcing wall 42A, with the shoulder part of the small-diameter portion 21a around the probe 22 pressed against the outer peripheral surface of the trunk 2. The probe 22 is given such a length that the outer end of the probe 22 placed in will be positioned in the reinforcing wall 42A at this time. A softened portion that will be produced at the start of and during joining can be prevented from scattering the metal material thereof by the shoulder portion pressed against the trunk to obtain a satisfactory joint, and the resulting joint can be precluded from forming burrs or like surface irregularities also by the pressed shoulder part.

Subsequently, the work of trunk 2 and head plate 41, and the friction agitation joining tool 20 are moved relative to each other to thereby move the probe 22 longitudinally of the trunk 2. Upon the probe 22 reaching the other end of the trunk 2, the direction of relative movement of the work including the trunk 2 and the head plate 41, and the joining tool 20 is changed to move the probe 22 toward the projection 44. The probe 22 is moved along the peripheral surface of the projection 44 to the outer end face, and withdrawn from the center of the end face of the projection 44. Consequently, the trunk 2 and the head plate 41 are joined to the reinforcing wall 42A of the reinforcing member 42 by friction agitation as described in detail with reference to Embodiment 1. Such a procedure is repeated for all the reinforcing walls 42A to join the trunk 2 and the head plate 41 to the reinforcing member 42. The projection 44 is then cut off from the head plate 41.

The other head plate 3 is joined to the reinforcing member 42 and the trunk 2 by friction agitation in the same manner as is in the case of Embodiment 1, a through bore 6a is formed in the projection 18, and the inner peripheral surface defining the bore 6a is threaded as at 11. In this way, a pressure vessel liner 40 is fabricated.

In Embodiment 3, the head plate 31 of Embodiment 2 may be used in place of the head plate 3. Furthermore, a head plate 4 made separately from the trunk 2 of Embodiment 1 may be used in place of the head plate 41 integral with the trunk 2.

Further in making the trunk 2 and the head plate 41 integrally by forging according to Embodiment 3 described, a mouthpiece portion having a through bore may be made integrally with the head plate 41. The mouthpiece portion is identical with the mouthpiece portion of Embodiment 2 described in shape. In this case, the head plate 4 of Embodiment 1 described is used as the other head plate.

### EMBODIMENT 4

This embodiment is shown in FIGS. 18 to 20.

In the case of a pressure vessel liner 50 according to this embodiment, a reinforcing member 5 integral with a trunk 2 is equal to the trunk 2 in length, and each end of the trunk 2 and the corresponding end of the reinforcing member 5 are positioned on the same plane. The liner 5 has opposite head plates 51, 52 which are each in the form of a flat plate having a flat inner surface. One of the head plates, 51, is provided with a mouthpiece portion 53 having an inner peripheral surface in the form of a cylindrical surface over the entire length thereof and defining a through bore 53a. The liner 50 otherwise has the same construction as the pressure vessel liner 1 of Embodiment 1 described.

As shown in FIG. 19, the pressure vessel liner 50 of Embodiment 4 is entirely covered with a fiber reinforced resin layer 9, for example, of carbon fiber reinforced resin for use as a high-pressure vessel 10. The fiber reinforced resin layer 9 has the same construction as in Embodiments 1 and 2 described.

The pressure vessel liner 50 is fabricated by the process to be described next.

An integral assembly of trunk 2 and reinforcing member 5 as shown in FIG. 20 is first extruded by an extruder (not shown) having a porthole die. Two head plates 51, 52 are each made by forging. At this time, a mouthpiece portion 53 having a through bore 53a is formed on the center of outer surface of one of the head plates, 51, integrally therewith, and an outwardly projecting solid cylindrical projection 18 is formed on the center of outer surface of the other head plate 52 integrally therewith. Since the head plate 51 is a flat plate, the joint of the bore-defining inner peripheral surface of the mouthpiece portion 5 and the inner surface of the head plate 51 is not rounded unlike the rounded portion of Embodiment 2 described even if the mouthpiece portion 5 having the bore 53a is formed simultaneously when the head plate 51 is made by forging.

While rotating the friction agitation joining tool 20, the probe 22 is then placed from outside into a peripheral edge portion of the head plate 51 having the mouthpiece portion 53, at a position corresponding to one of reinforcing walls 5A of the reinforcing member 5, with the shoulder part of the small-diameter portion 21a around the probe 22 pressed against the outer surface of the head plate 51. The probe 22 is given such a length that the outer end of the probe 22 placed in will be positioned in the reinforcing wall 5A at this time. Although not shown, the contact member 35 shown in FIG. 13 or the contact member 36 shown in FIG. 15 is positioned on the mouthpiece portion 53 as is the case with Embodiment 2 described.

The work of trunk 2 and head plate 51, and the joining tool 20 are thereafter moved relative to each other to move the probe 22 toward the mouthpiece portion 53 to join the head plate 51 to the reinforcing wall 5A by friction agitation. The probe 22 is further moved to the contact member 35 or 36, whereupon the probe 22 is withdrawn. Such a procedure is repeated for all the reinforcing walls 5A to join the head plate 51 to the reinforcing member 5.

Subsequently, the other head plate 52 is joined to all the reinforcing walls 5A of the reinforcing member 5 by friction agitation. This operation is conducted in the same manner as when the head plate 51 is joined to the reinforcing member 5 by friction agitation with the exception of withdrawing the probe 22 from the outer end face of the projection 18.

The two head plates 51, 52 are then joined to the trunk 2 by friction agitation in the same manner as in the case of Embodiment 1 described. The inner peripheral surface defining the through bore 53a is thereafter threaded as at 11, and the projection 18 is cut off from the head plate 52. In this way, a pressure vessel liner 50 is fabricated.

The mouthpiece portion 53 of the head plate 51 in Embodiment 4 described may be formed in the same manner as the mouthpiece portion 6 of the head plate 3 in Embodiment 1. Stated more specifically, the mouthpiece portion 53 may be made by forming a projection as on the head plate 52 in making the head plate 51 by forging, withdrawing the probe 22 from the outer end face of the projection when joining the head plate 51 to the reinforcing member 5 by friction agitation, and thereafter making the through bore 53a from the outer end face of the projection to the inner surface of the head plate 51.

In the pressure vessel liners of Embodiments 2 to 4, the trunk, head plates and reinforcing member are made from one of JIS A2000 alloy, JIS A5000 alloy, JIS A53000 alloy and JIS A7000.

In all the foregoing embodiments, the trunk is circular in cross section, whereas this is not limitative; the trunk may be shaped otherwise, for example, in an elliptical shape.

High-pressure vessels comprising a pressure vessel liner according to any one of Embodiments 1 to 4 are used in fuel cell systems which comprise a fuel hydrogen pressure vessel, a fuel cell and pressure piping for delivering fuel hydrogen gas from the pressure vessel to the fuel cell to serve as the fuel hydrogen pressure vessel. The fuel cell system is installed in motor vehicles. The fuel cell system is used also in cogeneration systems.

The high-pressure vessel is used also in natural gas supply systems which comprise a natural gas pressure vessel and pressure piping for delivering natural gas from the pressure vessel to serve as the natural gas pressure vessel. The natural gas supply system is used in cogeneration systems along with a generator and a generator drive device. The natural gas supply system is used also in natural gas motor vehicles equipped with an engine for use with natural gas as the fuel.

The high-pressure vessel is used further in oxygen gas supply systems which comprise an oxygen pressure vessel and pressure piping for delivering oxygen gas from the pressure vessel to serves as the oxygen pressure vessel.

### INDUSTRIAL APPLICABILITY

The present invention provides a pressure vessel liner suitable for use in pressure vessels for storing hydrogen gas or natural gas serving as a fuel for power generation, or for use in pressure vessels for storing oxygen gas , for example, in the automobile industry, housing industry, military industry, aerospace industry, medical industry, etc. The pressure vessel liner of the invention has an enhanced pressure resistant strength against longitudinal forces.

1. A pressure vessel liner comprising a tubular trunk and head plates for closing respective opposite end openings of the trunk, the trunk having a reinforcing member fixedly provided therein and extending longitudinally of the trunk for dividing interior of the trunk into a plurality of spaces, the head plates being joined to the reinforcing member.

2. A pressure vessel liner according to claim 1 wherein the combined length of joints between each of the head plates and the reinforcing member is at least 60% of the combined length of portions of the reinforcing member in contact with an inner surface of the head plate.

3. A pressure vessel liner according to claim 1 wherein the head plates are joined to the reinforcing member by friction agitation.

4. A pressure vessel liner according to claim 1 wherein the head plates are formed separately from the trunk and are joined respectively to opposite ends of the trunk.

5. A pressure vessel liner according to claim 1 wherein one of the head plates is formed integrally with one end of the trunk and the other head plate is formed separately from the trunk and joined to the other end of the trunk.

6. A pressure vessel liner according to claim 1 wherein at least one of the head plates is in the form of an outwardly bulging dome, and an end portion of the reinforcing member adjacent to the domelike head plate projects outward beyond the trunk and fitted in the domelike head plate.

7. A pressure vessel liner according to claim 1 wherein at least one of the head plates has a flat inner surface.

8. A process for fabricating a pressure vessel liner according to claim 1 including extruding a tubular trunk having opposite open ends and a reinforcing member extending longitudinally of the trunk and forming two head plates, inserting the reinforcing member into the trunk and joining the trunk to the reinforcing member, and joining the two head plates respectively to the opposite ends of the trunk and joining the two head plates to the reinforcing member.

9. A process for fabricating a pressure vessel liner according to claim 8 wherein the trunk is joined to the reinforcing member by friction agitation from outside the trunk.

10. A process for fabricating a pressure vessel liner according to claim 8 wherein one of the head plates is formed by forging and an outwardly extending projection is formed on an outer surface of said one head plate integrally therewith when said one head plate is formed by forging, and which includes providing a mouthpiece portion by forming a through bore extending from an outer end face of the projection to an inner surface of said one head plate after joining the two head plates respectively to the opposite ends of the trunk and joining the two head plates to the reinforcing member.

11. A process for fabricating a pressure vessel liner according to claim 8 wherein the head plates are joined to the reinforcing member by friction agitation from outside the head plates.

12. A process for fabricating a pressure vessel liner according to claim 1 including extruding a tubular trunk having opposite open ends and a reinforcing member extending longitudinally of the trunk and dividing interior of the trunk into a plurality of spaces in the form of an integral assembly and forming two head plates, and joining the two head plates respectively to the opposite ends of the trunk and joining the two head plates to the reinforcing member.

13. A process for fabricating a pressure vessel liner according to claim 12 wherein one of the head plates is formed by forging and an outwardly extending projection is formed on an outer surface of said one head plate integrally therewith when said one head plate is formed by forging, and which includes providing a mouthpiece portion by forming a through bore extending from an outer end face of the projection to an inner surface of said one head plate after joining the two head plates respectively to the opposite ends of the trunk and joining the two head plates to the reinforcing member.

14. A process for fabricating a pressure vessel liner according to claim 12 wherein the head plates are joined to the reinforcing member by friction agitation from outside the head plates.

15. A process for fabricating a pressure vessel liner according to claim 1 including forming a tubular trunk having opposite open ends and a head plate for closing one of the open ends of the trunk by forging in the form of an integral assembly, forming a head plate for closing the other open end of the trunk, extruding a reinforcing member extending longitudinally of the trunk, inserting the reinforcing member into the trunk and joining the trunk to the reinforcing member, and joining the head plate formed separately from the trunk to the other end of the trunk and joining the two head plates to the reinforcing member.

16. A process for fabricating a pressure vessel liner according to claim 15 wherein when the integral assembly of the trunk and the head plate is formed by forging, an outwardly extending projection is formed on an outer surface of the head plate integrally therewith, and which includes providing a mouthpiece portion by forming a through bore extending from an outer end face of the projection to an inner surface of the head plate after joining the head plate formed separately from the trunk to the other end of the trunk and joining the two head plates to the reinforcing member.

17. A process for fabricating a pressure vessel liner according to claim 15 wherein the head plate for closing the other open end of the trunk is formed by forging, and an outwardly extending projection is integrally formed on an outer surface of the head plate to be formed by forging, and which includes providing a mouthpiece portion by forming a through bore extending from an outer end face of the projection to an inner surface of the head plate after joining the head plate formed separately from the trunk to the other end of the trunk and joining the two head plates to the reinforcing member.

18. A process for fabricating a pressure vessel liner according to claim 15 wherein the trunk is joined to the reinforcing member by friction agitation from outside the trunk.

19. A process for fabricating a pressure vessel liner according to claim 15 wherein the head plates are joined to the reinforcing member by friction agitation from outside the head plates.

20. A pressure vessel comprising a pressure vessel liner according to claim 1 which is covered with a fiber reinforced resin layer over an outer peripheral surface thereof.

21. A fuel cell system comprising a fuel hydrogen pressure vessel, a fuel cell and pressure piping for delivering fuel hydrogen gas from the pressure vessel to the fuel cell therethrough, the fuel hydrogen pressure vessel comprising a pressure vessel according to claim 20.

22. A fuel cell motor vehicle having installed therein a fuel cell system according to claim 21.

23. A cogeneration system comprising a fuel cell system according to claim 21.

24. A natural gas supply system comprising a natural gas pressure vessel and pressure piping for delivering natural gas from the pressure vessel therethrough, the natural gas pressure vessel being a pressure vessel according to claim 20.

25. A cogeneration system comprising a natural gas supply system according to claim 24, a generator and a generator drive device.

26. A natural gas motor vehicle comprising a natural gas supply system according to claim 24 and an engine for use with natural gas as a fuel.
